(19) United States
(12) Patent Application Publication
(10) Pub. No.: US 2007/0144309 A1
(43) Pub. Date: Jun. 28, 2007

(54) Torque multiplier

(76) Inventor: Fernando Manuel Gil Aldrete, Municipio de Cuautitlan (MX)

Correspondence Address: FISHER, CHRISTEN & SABOL, 1725 K STREET, N.W., SUITE 1108, WASHINGTON, DC, 20006, US

(21) Appl. No.: 11/645,524

(22) Filed: Dec. 27, 2006

Related U.S. Application Data
(63) Continuation of application No. PCT/MX04/00041, filed on Jun. 30, 2004.

(30) Foreign Application Priority Data
Jun. 28, 2004 (MX) PA/A/04/06381

(51) Int. Cl. H02G 1/12

(52) U.S. Cl. 81/9.43; 74/572.2

(57) ABSTRACT

Subdevice formed from two cross-shaped pieces with four equal arms arranged at 90° angles and with a central bore, so aligned that eight arms are formed by pairs and in a parallel separated apart position, and connected by means of a piece at the central bore, aligned with the central bores of the two cross-shaped pieces, in such a manner that in the bores a shaft, that can be a motor shaft, is secured to become the rotation axis of the entire apparatus.

### DESCRIPTION OF THE PARTS COMPRISING THIS INVENTION

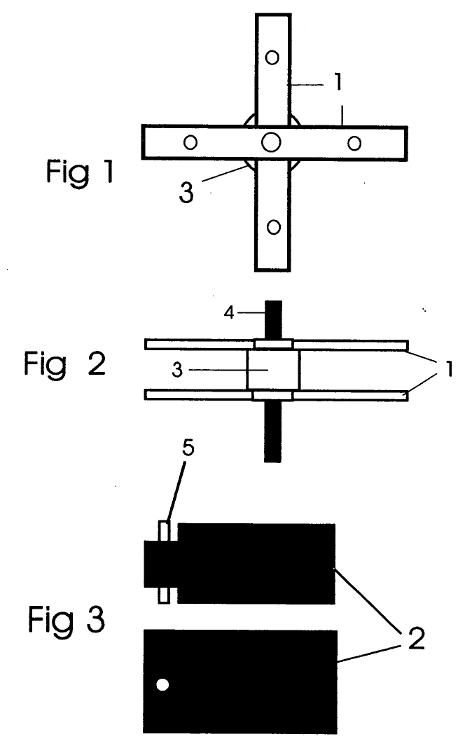

FIG. 1 represents two cross-shaped pieces (1) at 90°, with a central bore. These pieces are armed in a parallel position (see FIG. 2) separated apart and assembled by means of a piece (3) having a bore aligned with the central bores of the cross-shaped pieces. In these bores a shaft (4) is firmly connected, with said shaft (4) being the rotation axis of the entire torque multiplier; wherein said shaft can be a motor shaft.

FIG. 3 represents a rectangular piece in a frontal and profile (2) positions; with one of the ends of said pieces having a recess provided with a bore wherein a bolt (5) is received. Four pieces of this kind will be used to construct this invention. In order to make the disclosure easy they will be referred to as levers (2).

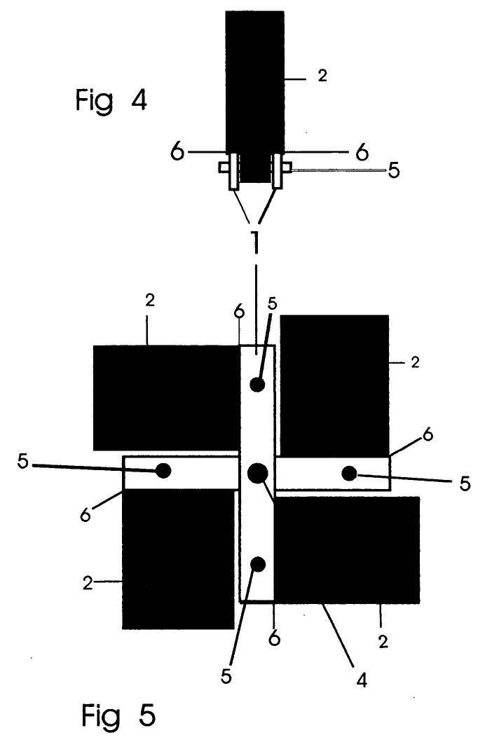

FIG. 4 discloses one of said four levers (2) connected between said two parallel pieces (1) by means of said bolt (5), and shows in detail how they become supported at the site (6) of the edge of said parallel pieces (1).

FIG. 5 shows in a front view the invention already assembled, with said four levers (2) arranged between said two parallel pieces (1) by means of said bolts (5). It is to be clearly understood that this bolt (5) must be at the center of the recess of said levers (2) and into a central bore or displaced towards the ends of the parallel arms of the cross-shaped pieces (1), wherein each of said four levers will become connected. Said four levers (2) are supported on the edge of the cross-shaped pieces (1); see the site (6) in FIGS. 4 and 5.

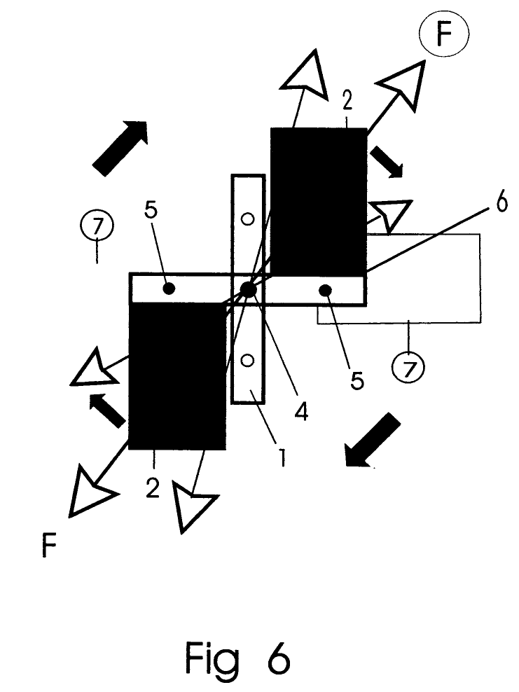

In order to explain the operation of this invention the attention is called to FIG. 6. In this illustration we consider that the apparatus makes a clockwise rotation; said levers (2) arranged between said cross-shaped parallel pieces (1) by means of the bolt (5), acquire upon rotation of the entire apparatus about the shaft (4), centrifugal force (see arrows (F)) whereby their masses obtain a strong drive to rotate on said bolt (5) and to be displaced following the same rotation direction (see position (7)). This reference numeral illustrates in an imaginary manner, the position to which said levers (2) would become displaced due to centrifugal force.

This cannot happen however, as the same bolt (5) maintains said levers bearing on the edges of said parallel pieces (1) and precisely on the ends (6) of the edges of said cross-shaped pieces, the site on which all of the centrifugal force is applied by the levering of said rectangular pieces (2) having a fulcrum on the bolt (5) and through the application of the centrifugal force on the site (6) resulting in an increase in the torque; with said torque increasing as the speed increases, since the speed produces an increase in the weight of the levers (2), whereby they increase their centrifugal force which is applied with a lever effect, thus increasing further the pressure on the ends (6) of the cross-shaped pieces in the same rotation direction, thus obtaining an increase of the torque at the rotation axis, which can be a motor shaft (4), wherein this TORQUE MULTIPLIER is installed.

Once sufficiently disclosed the parts and the operation of this invention, I consider as a novelty and therefore I claim as my exclusive property the contents of the following claims:

1. Formed from two cross-shaped pieces with four equal arms arranged at 90°angles and with a central bore (1), so aligned that eight arms are formed by pairs and in a parallel separated apart position, and connected by means of a piece (3) at the central bore, aligned with said central bores of said two cross-shaped pieces, in such a manner that in said bores a shaft (4), that can be a motor shaft, is secured to become the rotation axis of the entire apparatus (FIGS. 1-2).

2. Said cross-shaped pieces as disclosed in claim 1 form four 90° angles; in sad space four rectangular pieces (2) are installed doing a lever effect and having the following ratios (FIGS. 4 and 5): The thickness must be at least same as the dimension resulting from measuring the pairs of arms in said cross-shaped pieces (1) having a space therebetween, by measuring them on the outer side, so that said levers become supported on the edges of said arms of the cross-shaped pieces (1) (FIG. 4). The width must be of the same dimensions resulting from measuring the length of the arms (6) in the cross-shaped pieces (FIG. 5), and the length of these rectangular pieces (2) must be equal to one or more lengths of said cross-shaped pieces (1), and will also have a recess at one end thereof so that said recess can become installed at the space formed by the separation apart of said two arms of the cross-shaped pieces (FIG. 4) supported on the edges (6).

3. Said four rectangular pieces (2) of claim 2 are characterized by being supported on one of said pairs of cross-shaped pieces by means of a bolt (5); with said bolt maintaining them supported on the edges (6) of the arms of said cross-shaped pieces (1); said bolt being installed into a bore transversally to the cross-shaped pieces and at the recess of said rectangular pieces (2) that are connected by means of said pieces (FIG. 4); and said bore wherein said bolt (5) is installed will be formed at the mean portion of the arms of said cross-shaped pieces or will be displaced towards the ends (FIGS. 4-5).

4. The rectangular pieces (2) claimed in claim 2 are characterized in that they function as levers having said bolt (4) as their fulcrum which maintains them in place; and the edges (6) of said parallel cross-shaped pieces (1) are the site wherein the lever force is applied on.

5. The lever force is the result of the centrifugal force (F) of said rectangular pieces (2) claimed in claim 2, when rotate installed on the arms of said cross-shaped pieces disclosed in claim 1, which, in turn, rotate about the axis (4) (a motor shaft); said centrifugal force being continuously applied as a pressure on the ends (6) of the cross-shaped pieces during the rotation; whereby an increase in the torque is obtained that increases with the increase of the speed of the apparatus; since the increase in the speed produces a mass increase (i. e., a weight increase) of the four rectangular pieces disclosed in claim 2 which, due to their lever work, increase said torque.

6. The four rectangular pieces so-called levers (2) installed on a pair of arms positioned parallel to said cross-shaped pieces (1) as described in claim 2, can become positioned perpendicular to these pieces (1) to which are connected, or at some other pitch, and they can be rectangular, o with a combination of straight portions and curves, with this meaning no modification on the exclusive property of this patent.
